(19) United States
(12) Patent Application Publication
(10) Pub. No.: US 2009/0117867 A1
(43) Pub. Date: May 7, 2009

(54) SCALABLE BANDWIDTH SYSTEM AND METHOD OF CONTROLLING TUNABLE FILTER

(75) Inventors: Yun Soo KO, Daejeon (KR); Heon Kook KWON, Daejeon (KR); Joon Hyung KIM, Daejeon (KR); Seong-Min KIM, Daejeon (KR); Kwang Chun LEE, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/165,989

(22) Filed: Jul. 1, 2008

(30) Foreign Application Priority Data
Nov. 6, 2007 (KR) 10-2007-0112618

(51) Int. Cl. H04B 1/18

(52) U.S. Cl. 455/188.1

(57) ABSTRACT

The present invention relates to a scalable bandwidth system and a method of controlling a tunable filter. In the present invention, the scalable bandwidth system inputs, as a control signal of a tunable filter, a voltage corresponding to a section in which the capacitance according to an applied voltage is not practically changed for characteristics of varactor diodes, and inputs each control bit of the control signal to each varactor diode of the tunable filter to adjust the capacitance of each of the varactor diodes, and consequently adjusts the capacitance of the tunable filter by adding the capacitance of the varactor diodes.

### CROSS-REFERENCE TO RELATED APPLICATION

This application claims priority to and the benefit of Korean Patent Application No. 10-2007-0112618 filed in the Korean Intellectual Property Office on Nov. 6, 2007, the entire contents of which are incorporated herein by reference.

### BACKGROUND OF THE INVENTION

(a) Field of the Invention

The present invention relates to a scalable bandwidth system and a method of controlling a tunable filter.

The present invention is concluded from work that was supported by the IT R&D program of MIC&IITA [2006-S-001-02, Development of Adaptive Radio Access and Transmission Technologies for 4th Generation Mobile Communications].

(b) Description of the Related Art

In the related art, a scalable bandwidth system varies the channel band of a tunable filter by adjusting capacitance of the tunable filter using a varactor diode, and uses an analog control voltage or current as a control signal of the varactor diode.

However, when the analog control voltage or current is used as a control signal of the varactor diode as described above, the capacitance thereof considerably changes even if a small amount of noise is added to the control voltage or the control current, such that the channel band of the tunable filter changes.

### SUMMARY OF THE INVENTION

The present invention has been made in an effort to provide a scalable bandwidth system for providing a tunable filter that is not substantially affected by noise, and a method of controlling the tunable filter.

In order to achieve the objects, a method of controlling a tunable filter including a plurality of diodes according to an exemplary embodiment of the present invention includes:

when a characteristic line of a capacitance with respect to a voltage corresponding to the diodes is divided into a first section in which the slope is below a predetermined level, a second section that is adjacent to the first section and in which the slope is above the predetermined level, and a third section that is adjacent to the second section and in which the slope is below the predetermined level, selecting a channel band, selecting each of a plurality of control bits from one of a first voltage corresponding to the first section and a second voltage corresponding to the third section, on the basis of the selected channel band, and outputting each of the control bits to a corresponding diode of the diodes.

Further, a scalable bandwidth system according to an exemplary embodiment of the invention includes: at least one of tunable filter portions having an inductor and a plurality of diodes that are coupled in parallel, and filtering and outputting a pass band corresponding to inductance of the inductor and capacitance of the diodes, and a controller controlling the capacitance using control bits corresponding to each of the diodes.

### BRIEF DESCRIPTION OF THE DRAWINGS

FIG. 1 is a view illustrating the configuration of a scalable bandwidth system according to an exemplary embodiment of the present invention.

FIG. 2 is a view illustrating changes in capacitance with respect to a voltage applied to a common varactor diode.

FIG. 3 is a view illustrating a method of controlling a tunable filter of a scalable bandwidth system according to an exemplary embodiment of the present invention.

FIG. 4 is a view illustrating the configuration of an n-degree tunable filter according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

It will be further understood that the terms “comprises” and/or “comprising”, when used in this specification, specify the presence of stated components, but do not preclude the presence or addition of one or more other components, unless specifically stated. In addition, the terms “-er”, “-or”, “module”, and “block” described in the specification mean units for processing at least one function and operation, and can be implemented by hardware components or software components, and combinations thereof.

Hereafter, a scalable bandwidth system and a method of controlling a tunable filter according to exemplary embodiments of the present invention are described in detail with reference to the accompanying drawings.

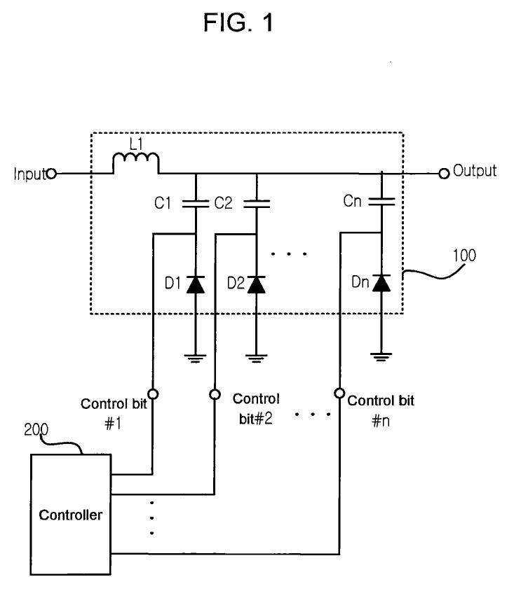

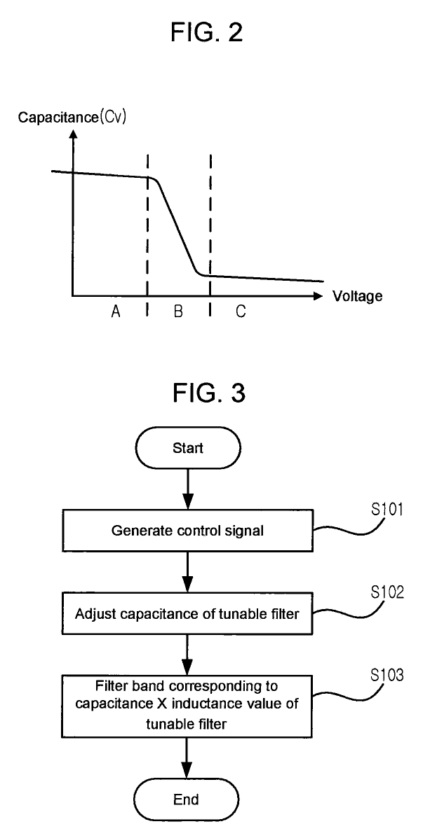

FIG. 1 is a view illustrating the configuration of a scalable bandwidth system according to an exemplary embodiment of the present invention, in which the scalable bandwidth system supports a multiple band. Further, FIG. 2 is a view illustrating changes in capacitance with respect to a voltage applied to a common varactor diode.

Referring to FIG. 1, a scalable bandwidth system includes a tunable filter 100 and a controller 200.

The tunable filter 100 includes an inductor L1, a plurality of varactor diodes D1, D2, . . . , Dn, and a plurality of capacitors C1, C2, . . . , Cn, and performs a filter function in response to digital control signals (control bit #1, control bit #2, . . . , control bit #n) inputted from the controller 200.

The first terminal of the inductor L1 of the tunable filter 100 is connected with an input terminal and the second terminal is connected with an output terminal. Further, the first terminal of each of the capacitors C1, C2, . . . , Cn is connected with the second terminal of the inductor L1 and the second terminal of each of the capacitors C1, C2, . . . , Cn is connected with a cathode terminal of each of the diodes D1, D2, . . . , Dn. In addition, each of the control bits (control bit #1, control bit #2, . . . , control bit #n) of a control signal is inputted to the cathode terminal of each of the diodes D1, D2, . . . , Dn, and an anode terminal of each diode D1, D2, . . . , Dn is connected to the ground terminal.

In this embodiment, the inductor L1 generates inductance of the tunable filter 100, and each of the capacitors C1, C2, . . . , Cn functions as a bypass capacitor. The varactor diodes D1, D2, . . . , Dn that are coupled in parallel adjust the capacitance of the tunable filter 100, and each of the varactor diodes D1, D2, . . . , Dn adjusts the capacitance based on each control bit.

The controller 200 outputs control signals for adjusting the capacitance of the tunable filter 100 on the basis of channel band selected in the scalable bandwidth system. That is, the controller 200 outputs control signals including the control bits (control bit #1, control bit #2, . . . , control bit #n) that adjust the capacitance of each of the varactor diodes D1, D2, . . . , Dn of the tunable filter 100 to adjust the capacitance of the tunable filter 100.

Referring to FIG. 2, a varactor diode has a characteristic that capacitance Cv decreases as an applied voltage is larger in which the larger an applied voltage, the more the varactor diode decreases in capacitance Cv.

Referring to FIG. 2, the capacitance Cv is not practically changed in a section A and a section C, with respect to the applied voltage. That is, the slope of the decreasing lines of the capacitance Cv in the section A and the section C is substantially 0, that is, the lines are almost horizontal. On the other hand, the capacitance Cv linearly decreases with respect to the applied voltage in a section B.

In the related art, as shown in FIG. 2, the capacitance of the tunable filter is adjusted by varying the control voltage (or control current) in the section B to adjust the capacitance Cv of the varactor diode, using the characteristic of the capacitance of the varactor diode. However, when the analog control voltage is used as described above, the capacitance Cv of the varactor diode changes considerably even if a small amount of noise is included in the control voltage, such that the channel band of the tunable filter changes. Further, because a digital to analog converter (DAC) that converts a digital control signal into an analog control voltage (of control current) is needed to generate the control voltage, the hardware becomes complicated.

On the contrary, in the exemplary embodiment of the present invention, the controller 200 adjusts the capacitance Cv of the varactor diode, using digital signals corresponding to control voltages applied in the sections A and C, but not in the section B, as control signals. For example, about 0V is used as a digital signal 0 (low) in the section A and about 5V is used as a digital signal 1 (high) in the section C, and a digital control bit corresponding to 0 or 1 is inputted to each varactor diode. Accordingly, each varactor diode has high or low capacitance Cv in response to each control bit 0 or 1, and as shown in FIG. 1, each capacitance Cv of the varactor diodes C1 to Cn coupled in parallel are added and consequently the capacitance of the tunable filter is adjusted.

As described above, according to the method of using voltages in the sections with practically no changes in the capacitance Cv of the varactor diode as digital control signals and finally adjusting the capacitance of the tunable filter by adding each capacitance Cv of the varactor diodes that is adjusted by each control bit, the control signals are not practically affected by noise and a separate DAC is not needed, thereby reducing complexity of the hardware. Further, by coupling parallel varactor diodes having small difference characteristics, it is possible to design a tunable filter that can be applied to a variety of channel bands, depending on combinations of control bits.

FIG. 3 is a view illustrating a method of controlling a tunable filter for supporting a multiple band in a scalable bandwidth system according to an exemplary embodiment of the present invention.

Referring to FIG. 3, once a channel band is determined, the system generates a digital control signal corresponding to the determined channel band, using the controller 200 (S101). Each control bit of the control signal is represented by a voltage corresponding to a section in which the capacitance is not practically changed for the characteristics of the varactor diode, and the capacitance of each varactor diode is adjusted according to corresponding control bits.

Therefore, the capacitance of the varactor diodes that are adjusted according to each control bit are added and the capacitance of the tunable filter 100 is adjusted (S102), and the pass band of the corresponding tunable filter 100 is set to a desired channel band by the inductance and the capacitance of the tunable filter 100.

Accordingly, the tunable filter 100 performs a band filtering on the basis of the determined pass band (S103).

On the other hand, in the exemplary embodiment shown in FIG. 1, the degree of the tunable filter is 1, but a large-degree tunable filter may be designed to increase the available range of the pass band according to an exemplary embodiment of the present invention.

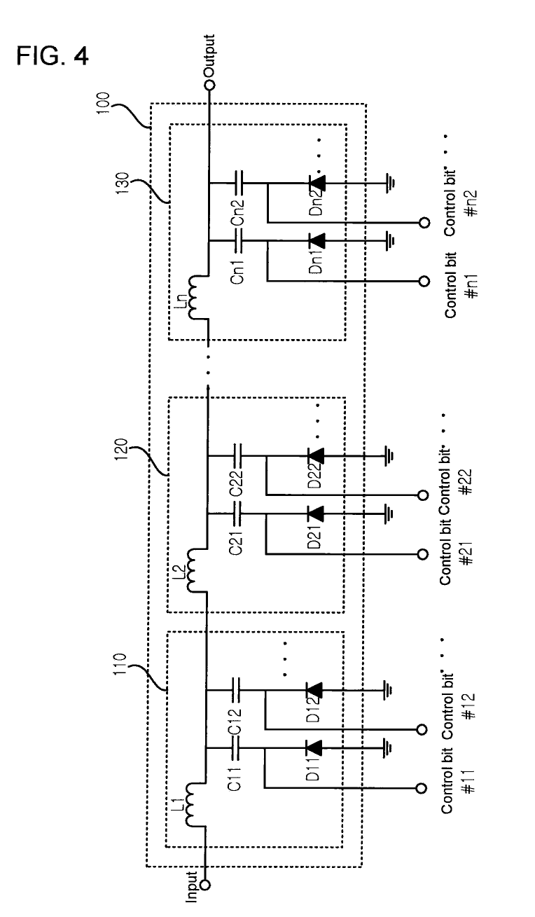

FIG. 4 is a view showing an n-degree tunable filter 100 according to an exemplary embodiment of the present invention. Referring to FIG. 4, the n-degree tunable filter includes n tunable filter portions 110, 120, and 130 between the input terminal and the output terminal, and each of the tunable filter portions 110, 120, 130 has the same configuration as the tunable filter 100 shown in FIG. 1.

On the other hand, varactor diodes are used to adjust the capacitance of the tunable filter in an exemplary embodiment of the present invention, but it is possible to achieve a tunable filter using other diodes having the characteristics of capacitance with respect to an applied voltage as shown in FIG. 2.

According to the present invention, by using a voltage in a section in which the capacitance of the varactor diode is not practically changed as a control signal of the varactor diode of the tunable filter, the tunable filter is not substantially affected by noise. Further, by using a digital signal as a control signal, a separate digital-to analog converter is not needed to convert a control signal into an analog control voltage or control current, thereby reducing complexity of hardware of the scalable bandwidth system.

Further, since the tunable filter includes varactor diodes that have characteristics that are somewhat different from each other and are coupled in parallel, it is possible to design a tunable filter that can be applied to a variety of channel bands, depending on combinations of control bits.

The embodiment of the present invention described above is not only implemented by the method and apparatus, but it may be implemented by a program for executing the functions corresponding to the configuration of the exemplary embodiment of the present invention or a recording medium having the program recorded thereon. These implementations can be realized by the ordinarily skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling a tunable filter including a plurality of diodes, comprising:
when a characteristic line of capacitance with respect to a voltage corresponding to the diodes is divided into a first section in which the slope is below a predetermined level, a second section that is adjacent to the first section and in which the slope is above the predetermined level, and a third section that is adjacent to the second section and in which the slope is below the predetermined level:
selecting a channel band;
selecting each of a plurality of control bits from one of a first voltage corresponding to the first section and a second voltage corresponding to the third section, on the basis of the selected channel band; and
outputting each of the control bits to a corresponding one of the diodes.

2. The method of claim 1, wherein the capacitance in the first section is higher than the capacitance in the second section, and the first voltage corresponds to a digital signal 0 and the second voltage corresponds to a digital signal 1.

3. The method of claim 1, wherein the capacitance characteristic lines of the diodes are different from each other.

4. The method of claim 1, wherein capacitance of the tunable filter is adjusted by adding the capacitance of the diodes.

5. The method of claim 4, wherein the diodes are varactor diodes.

6. The method of claim 5, wherein the diodes are coupled in parallel.

7. A scalable bandwidth system, comprising:
at least one tunable filter portion having an inductor and a plurality of diodes that are coupled in parallel, and filtering and outputting a pass band corresponding to inductance of the inductor and capacitance of the diodes; and
a controller controlling the capacitance using control bits corresponding to each of the diodes.

8. The system of claim 7, wherein each of the diodes has characteristics of capacitance with respect to a voltage divided into a first section in which the slope is below a predetermined level, a second section that is adjacent to the first section and in which the slope is above the predetermined level, and a third section that is adjacent to the second section and in which the slope is below the predetermined level, and the controller outputs the corresponding control bits from one of a first voltage corresponding to the first section and a second voltage corresponding to the third section of each of the diodes.

9. The system of claim 7, wherein a first terminal and a second terminal of the inductor are respectively connected with an input terminal and an output terminal of the tunable filter portion, and each cathode terminal and each anode terminal of the diodes is respectively connected to the second terminal of the inductor and a ground terminal.

10. The system of claim 9, wherein the tunable filter portion further comprises a plurality of bypass capacitors between the first terminal of the inductor and each cathode terminal of the diodes.

11. The system of claim 10, wherein each cathode terminal of the diodes is connected with a plurality of control bits, and
the controller selects each of the control bits, using one of the first voltage and the second voltage, and adjusts equivalent capacitance for each of the diodes.

12. The system of claim 11, wherein the capacitance is generated by adding the equivalent capacitance for each of the diodes.

13. The system of claim 7, wherein the diode is a varactor diode.
